(19) United States
(12) Patent Application Publication
(10) Pub. No.: US 2004/0109176 A1
(43) Pub. Date: Jun. 10, 2004

(54) Printing system and distributed image forming method

(76) Inventor: Yoshihito Osari, Tokyo (JP)

Correspondence Address: ROSSI & ASSOCIATES, P.O. Box 826, Ashburn, VA, 20146-0826, US

(21) Appl. No.: 10/647,901

(22) Filed: Aug. 25, 2003

(30) Foreign Application Priority Data
Aug. 28, 2002 (JP) 2002-248636 (PAT.

(51) Int. Cl. G06F 15/00; G06K 15/02; G06F 13/00

(52) U.S. Cl. 358/1.2; 358/1.15; 358/1.18

(57) ABSTRACT

There is provided a printing system which enable image output with a uniform image quality as a whole even in the case where a plurality of image forming apparatuses are caused to carry out distributed printing. A plurality of image forming apparatuses carry out image formation on a sheet. Margins in which no image is formed in the image formation carried out by each of the plurality of image forming apparatuses are stored. An optimum margin having a maximum value is selected from among the stored margins for each of the plurality of image forming apparatuses. An effective image area found from the selected optimum margin and the size of the sheet on which the image formation is to be carried out is calculated. Image data is adjusted for each of the plurality of image forming apparatuses such that an image to be formed based on the image data fits within the calculated effective image.

### BACKGROUND OF THE INVENTION

1. Field of the Invention

The present invention relates to a printing system and a distributed image forming method, and more particularly to a printing system that includes a plurality of image forming apparatuses, and distributes an image forming job to the plurality of image forming apparatuses and causes them to carry out distributed image formation, and a distributed image forming method applied to the printing system.

2. Description of the Related Art

Conventionally, to print electronic data using an image forming apparatus such as a printer in the case where a large number of copies or pages are required to be outputted, only one image forming apparatus capable of printing at a high output speed has been generally used. However, if it is desired to improve the output speed and the stability using only one image forming apparatus, the size of the image forming apparatus itself needs to increased, and hence the installation location can become a problem. Therefore, a method in which a large amount of data is outputted by distributed printing using a plurality of image forming apparatuses has become more widely used with the aid of diffusion of a network printer and improvement of the network transmission speed, instead of the method in which a large number of data is outputted using only one high-speed image forming apparatus.

Further, output data including color data pages has become more commonly used, and accordingly, a printing system that carries out distributed printing by causing black-and-white printers to output black-and-white data and causing color printers to output color data, and then combines the black-and-white data and the color data into one document has been proposed. For example, in the case where almost all pages of output data are black-and-white data and only a small amount of color data is included in the output data, the distributed printing method is more advantageous in terms of the productivity as compared with the method in which all data is outputted using only color printers.

In the case where distributed printing is carried out using a plurality of image forming apparatuses, it is desirable that image outputs with a uniform image quality as a whole should be obtained irrespective of capabilities and adjustment conditions peculiar to the respective image forming apparatuses.

Conventionally, however, in the case where distributed printing is carried out using a plurality of image forming apparatuses, an effective image area as the maximum image area in which an image can be formed differs according to variations in transfer sheet conveying performance and image forming performance between the respective image forming apparatuses.

Specifically, for the case where only one image forming apparatus is used for printing, a method in which an image is shifted or adjusted in magnification according to margins and an effective image area derived therefrom peculiar to the image forming apparatus has been proposed. According to this method, image output is enabled without causing problems such as image chipping, irrespective of individual image forming apparatuses each used as one image forming apparatus. However, even if this method is applied to distributed printing using a plurality of image forming apparatuses, output results of respective pages may have effective image areas in different sizes, which makes it impossible to obtain image outputs with a uniform image quality throughout a document by distributed printing.

### SUMMARY OF THE INVENTION

It is an object of the present invention to provide a printing system and a distributed image forming method, which enable image output with a uniform image quality as a whole even in the case where a plurality of image forming apparatuses are caused to carry out distributed printing.

To attain the above object, in a first aspect of the present invention, there is provided a printing system comprising a plurality of image forming apparatuses that carry out image formation on a sheet, a margin storage device that stores margins in which no image is formed in the image formation carried out by each of the plurality of image forming apparatuses, an optimum margin selecting device that selects an optimum margin having a maximum value from among the margins for each of the plurality of image forming apparatuses, stored by the margin storage device, an image area calculating device that calculates an effective image area found from the optimum margin selected by the optimum margin selecting device and a size of the sheet on which the image formation is to be carried out, and an image data adjusting device that adjusts image data for each of the plurality of image forming apparatuses such that an image to be formed based on the image data fits within the effective image area calculated by the image area calculating device.

To attain the above object, the first aspect of the present invention also provides a distributed image forming method applied to a printing system that includes a plurality of image forming apparatuses, and distributes an image forming job to the plurality of image forming apparatuses to cause the plurality of image forming apparatuses to carry out distributed image formation, comprising a storing step of storing margins in which no image is to be formed in the image formation carried out by each of the plurality of image forming apparatuses, a selecting step of selecting an optimum margin having a maximum value from among the margins for each of the plurality of image forming apparatuses, stored in the storing step, a calculating step of calculating an effective image area found from the optimum margin selected in the selecting step and a size of the sheet on which the image formation is to be carried out, and an adjusting step of adjusting image data for each of the plurality of image forming apparatuses such that an image to be formed based on the image data fits within the effective image area calculated in the calculating step.

According to the first aspect of the present invention, the optimum margin having the maximum value is selected from among margins on which no image is formed in image formation by a plurality of image forming apparatuses, and an effective image area is calculated based on the selected optimum margin and the size of a sheet on which an image is to be formed, and image data is adjusted for each image forming apparatus such that the image to be formed based on the image data can fit within the calculated effective image area. As a result, even if a plurality of image forming apparatuses are used to carry out distributed printing, the sizes of effective image areas on all pages are the same, and hence printouts with a uniform image quality as a whole can be obtained.

Preferably, the margin storage device stores respective margins at four ends of the sheet, and the optimum margin selecting device selects the optimum margin having the maximum value for each of the four ends.

Preferably, the margin storage device, the optimum margin selecting device, the image area calculating device, and the image data adjusting device are provided in one of the plurality of image forming apparatuses.

Preferably, the printing system according to the first aspect further comprises an image data server that distributes image data to the plurality of image forming apparatuses, and the margin storage device, the optimum margin selecting device, the image area calculating device, and the image data adjusting device are provided in the image data server.

Preferably, the printing system according to the first aspect comprises an input device that inputs the margins to be stored by the margin storage device through setting operations by a user.

Preferably, the printing system according to the first aspect further comprises a collecting device that collects margins from the plurality of image forming apparatuses, transmits the margins to the margin storage device to cause the margin storage device to store the margins.

Preferably, the image data adjusting device reduces the size of the image such that the image to be formed based on the image data fits within the effective image area. Alternatively, the image data adjusting device erases part of the image which is located outside the effective image area. Still alternatively, the image data adjusting device shifts part of the image which is located outside the effective image area into the effective image area.

Since the size of an image to be outputted is thus adjusted such that the image fits within the effective print area, image chipping can be prevented.

Also preferably, the image data adjusting device adjusts the image data for each of the plurality of image forming apparatuses using one method selected by a user from among a plurality of image data adjusting methods for fitting the image within the effective image area calculated by the image area calculating device.

To attain the above object, in a second aspect of the present invention, there is provided a printing system comprising a plurality of image forming apparatuses that carry out image formation on a sheet, a margin storage device that stores margins in which no image is to be formed in the image formation carried out by each of the plurality of image forming apparatuses, an optimum margin selecting device that selects an optimum margin having a maximum value from among the margins for each of the plurality of image forming apparatuses, stored by the margin storage device, an image area calculating device that calculates an effective image area found from the optimum margin selected by the optimum margin selecting device and a size of the sheet on which the image formation is to be carried out, an out-of-area image determining device that compares the effective image area calculated by the image area calculating device with an image to be subjected to the image formation carried out by each of the plurality of image forming apparatuses, and determines whether part of the image is located outside the effective image area, and a display device that displays a warning when the out-of-area image determining device determines that part of the image is located outside the effective image area.

To attain the above object, the second aspect of the present invention also provides a distributed image forming method applied to a printing system that includes a plurality of image forming apparatuses, and distributes an image forming job to the plurality of image forming apparatuses to cause the plurality of image forming apparatuses to carry out distributed image formation, comprising a storing step of storing margins in which no image is to be formed in the image formation carried out by each of the plurality of image forming apparatuses, a selecting step of selecting an optimum margin having a maximum value from among the margins for each of the plurality of image forming apparatuses, stored in the storing step, a calculating step of calculating an effective image area found from the optimum margin selected in the selecting step and a size of the sheet on which the image formation is to be carried out, a determining step of comparing the effective image area calculated in the calculating step with an image to be subjected to the image formation by each of the plurality of image forming apparatuses, and determining whether part of the image is located outside the effective image area, and a displaying step of displaying a warning when it is determined in the determining step that part of the image is located outside the effective image area.

According to the second aspect of the present invention, it is possible to prevent pages outputted by distributed printing from differing in appearance.

Preferably, the out-of-area image determining device is provided in one of the plurality of image forming apparatuses.

Preferably, the printing system according to the second aspect further comprises an image data server that distributes image data to the plurality of image forming apparatuses, and the out-of-area image determining device is provided in the image data server.

Preferably, the printing system according to the second aspect further comprises a processing control device operable when the out-of-area image determining device determines that part of the image is located outside of the effective image area, for providing control to continue or discontinue the image formation in accordance with an instruction from a user.

Preferably, the printing system according to the second aspect further comprises a host apparatus that instructs each of the plurality of image forming apparatuses to carry out distributed image formation, and wherein the out-of-area image determining device and the display device are provided in the host apparatus, the host apparatus operating the out-of-area image determining device and the display device before instructing each of the plurality of image forming apparatuses to carry out the distributed image formation.

To attain the above object, in a third aspect of the present invention, there is provided a printing system comprising a plurality of image forming apparatuses that are capable of carrying out distributed image formation according to an image forming job distributed to the plurality of image forming apparatuses, an image area detecting device that detects a minimum size among maximum sizes in which image formation can be carried out by respective ones of the plurality of image forming apparatuses, and regards an area of the detected minimum size as a common effective image area, and an image data adjusting device that adjusts image data to be subjected to the distributed image formation carried out by each of the plurality of image forming apparatuses such that an image to be formed based on the image data fits within the common effective image area detected by the image area detecting device.

To attain the above object, the third aspect of the present invention also provides a distributed image forming method applied to a printing system that includes a plurality of image forming apparatuses, and distributes an image forming job to the image forming apparatuses to cause the plurality of image forming apparatuses to carry out distributed image formation, comprising an image area detecting step of detecting a minimum size among maximum sizes in which the image formation is can be carried out by respective ones of the plurality of image forming apparatuses, and regarding an area of the detected minimum size as a common effective image area, and an image data adjusting step of adjusting image data to be subjected to the distributed image formation carried out by each of the plurality of image forming apparatuses such that an image to be formed based on the image data fits within the common effective image area detected in the image area detecting step.

The above and other objects, features, and advantages of the invention will become more apparent from the following detailed description taken in conjunction with the accompanying drawings.

### BRIEF DESCRIPTION OF THE DRAWINGS

FIGS. 1A and 1B are diagrams schematically showing the arrangements of two printing systems according to a first embodiment of the present invention;

FIG. 2 is a sectional view showing an example of an image forming apparatus that can be used in a networked environment and constitutes both a multi-function machine and a master printer;

FIG. 3 is a block diagram showing the construction of a controller in the main body of the image forming apparatus;

FIG. 4 is a block diagram showing the internal construction of an image processing section and a printer section;

FIG. 5 is a block diagram showing the internal construction of an image memory section;

FIG. 6 is a block diagram showing the internal construction of an external I/F processing section;

FIG. 7 is a view showing a data table showing the relationship between sheet margins at the leading end, trailing end, right end, and left end and identifiers for identifying respective image forming apparatuses;

FIG. 8 is a view showing the optimum margins;

FIG. 9 is a flow chart showing a distributed printing process carried out by an image data server or a master printer according to the first embodiment;

FIGS. 10A and 10B are flow chart showing a distributed printing process carried out by an image data server or a master printer according to a second embodiment of the present invention;

FIGS. 11A and 11B are flow chart showing a distributed printing process carried out by an image data server or a master printer according to a third embodiment of the present invention;

FIG. 12 is a flow chart showing a distributed printing process carried out by an image data server or a master printer according to a fourth embodiment of the present invention;

FIG. 13 is a flow chart showing a distributed printing process carried out by an image data server or a master printer according to a fifth embodiment of the present invention; and

FIG. 14 is a flow chart showing a distributed printing process carried out by an image data server or a master printer according to a sixth embodiment of the present invention.

### DETAILED DESCRIPTION OF THE PREFERRED EMBODIMENTS

The present invention will now be described in detail with reference to the drawings showing preferred embodiments thereof.

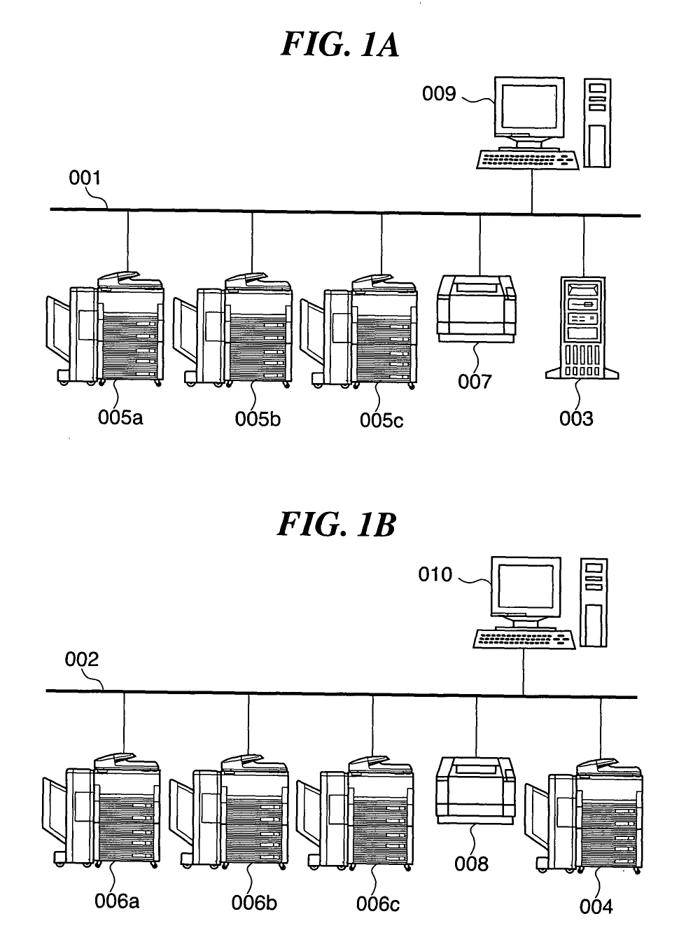

FIG. 1 is a diagram showing the arrangements of two printing systems according to a first embodiment of the present invention. Although the two printing systems will be described below at the same time, the arrangement in FIG. 1A and the arrangement in FIG. 1(B) are not compatible but alternative.

In FIGS. 1A and 1B, reference numerals 001 and 002 each denote a LAN installed in an office, which is schematically illustrated. Reference numeral 003 denotes an image data server. Reference numerals 005a to 005c, 006a to 006c, 007, and 008 denote respective image forming apparatuses connected to each other on the LANs 001 and 002. Each of the image forming apparatuses 005a to 005c and 006a to 006c is a multi-function machine provided with an image reading function (scanner function) and an image forming function (printer function).

The image data server 003 receives and stores image data transmitted from respective scanners which are provided in a computer 009 installed on the LAN 001 and the multi-function machines 005a to 005c, and divides image data stored in the image data server 003 and redistributes the divided image data to the multi-function machines 005a to 005c and the image forming apparatus 007, so that a plurality of image forming apparatuses carry out distributed printing. In distributed printing, the image data server 003 divides a document job comprised of a sequence of received image data on a page-by-page basis or on a job-by-job basis, and distributes the divided document job to the multi-function machines 005a to 005c and the image forming apparatus 007. Further, the image data server 003 controls distributed printing, scheduling, and so forth, and also controls processing of data for each page or for each job, error recovery, and so forth.

The master printer 004 is an image forming apparatus similar in construction to the multi-function machines 005a to 005c and 006a to 006c, but differs from them in that the master printer 004 has an image data server function of controlling distributed printing as is the case with the image data server 003.

The master printer 004 is capable of receiving and storing image data transmitted from scanners in a computer 010 installed on the LAN 002 and scanners in the multi-function machines 006a to 006c, and redistributing the image data to the multi-function machines 006a to 006c and the image forming apparatus 008 as well as the master printer 004 itself. In this way, distributed printing can be realized on the LAN 202, too.

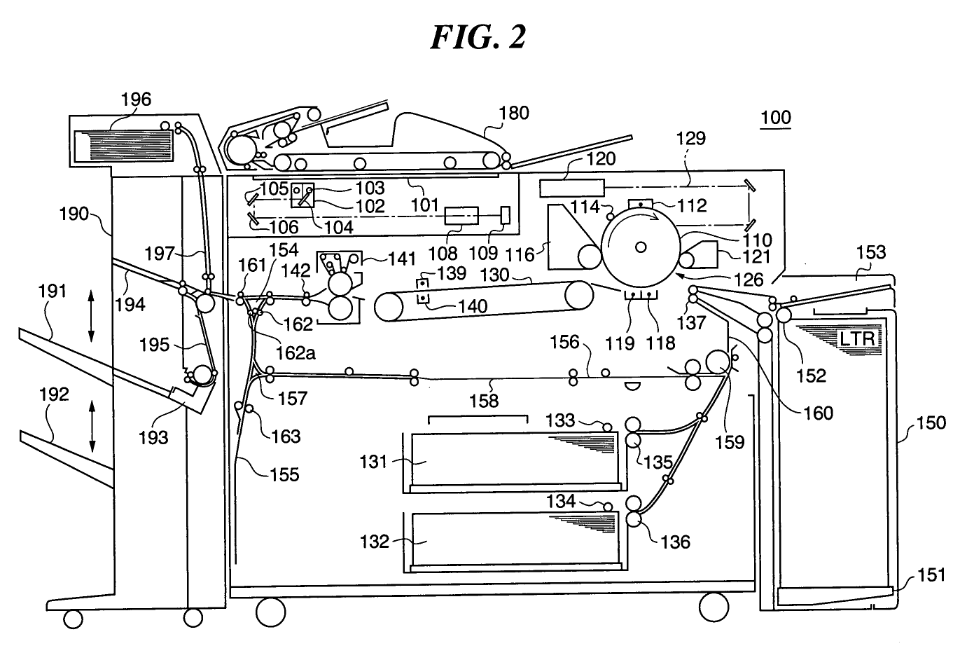

FIG. 2 is a sectional view showing an example of an image forming apparatus that can be used in a networked environment and constitutes both the multi-function machines 005a to 005c and 006a to 006c and the master printer 004. The image forming apparatus in FIG. 2 includes a scanner section (image reading section) and a printer section (image forming section). It should be noted, however, that the image forming apparatuses 007 and 008 include only the printer section (image forming section).

In FIG. 2, reference numeral 100 denotes an apparatus main body, and reference numeral 180 denotes an automatic document feeder (DF).

In FIG. 2, reference numeral 101 denotes a platen glass on which an original is to be placed, and reference numeral 102 denotes a scanner. The scanner 102 is comprised of an original illumination lamp 103, a scanning mirror 104, and so forth. The scanner 102 is driven by a motor, not shown, to scan the original on the platen glass 101 back and forth in a predetermined direction, and light reflected from the original is transmitted to an image sensor (CCD sensor) 109 via a lens 108 so that an image can be formed.

A description will now be given of the printer section (image forming section). An exposure control section 120 is comprised of optical elements such as a laser and scanner, and is adapted to emit a laser light 129 based on an image signal converted into an electric signal by the image sensor 109 and subjected to predetermined processing, described later. The laser light 129 is irradiated upon a photosensitive drum 110.

A primary electrifier 112, a developing unit 121, a transfer electrifier 118, a cleaner 116, and a pre-exposure lamp 114 are arranged around the photosensitive drum 110. In the image forming section 126, the photosensitive drum 110 rotates in a direction indicated by the arrow in FIG. 2, and is charged with a desired voltage by the primary electrifier 112. The laser light 129 is then irradiated upon the photosensitive drum 112 to form an electrostatic latent image thereon. The electrostatic latent image formed on the photosensitive drum 110 is developed by the developing unit 121 and visualized as a toner image.

On the other hand, a transfer sheet fed from an upper cassette 131 or a lower cassette 132 by a pair of pickup rollers 133 or 134 is conveyed to the photosensitive drum 110 by a pair of sheet feed rollers 135 or 136, and is fed to a transfer belt 130 by a pair of resist rollers 137. On this occasion, the visualized toner image is transferred onto the transfer sheet by the transfer electrifier 118. After the transfer, residual toner and residual electric charge on the photosensitive drum 110 are removed by the cleaner 116 and the pre-exposure lamp 114, respectively.

The transfer sheet on which the image has been transferred is separated from the transfer belt 130, and is conveyed to a fixing device 141 after the toner image is electrified again by pre-fixing electrifiers 139 and 140. The fixing device 141 carries out fixing on the transfer sheet, which is then discharged from the apparatus main body 100 by discharge rollers 142.

A deck 150, which is capable of storing four thousand transfer sheets, for example, is attached to the apparatus main body 100. The deck 150 is provided with a lifter 151, which moves up according to the amount of transfer sheets so that a transfer sheet can constantly be in contact with a sheet feed roller 152. Further, a multi-manual feed cassette 153, which is capable of storing one hundred transfer sheets, is attached to the apparatus main body 100.

Further, in FIG. 2, reference numeral 154 denotes a sheet discharge flapper that enables the transfer sheet conveying path to be switched to a double-sided recording path and a multi-recording path or to a discharge path. If the discharge path is selected, the sheet discharge flapper 154 is lowered (rotated clockwise as viewed in FIG. 2), so that the transfer sheet is conveyed to the discharge path (a left side as viewed in FIG. 2) and discharged from the image forming apparatus by a pair of discharge rollers 161. On the other hand, if a double-sided recording or multi-recording mode is set as the recording mode, the sheet discharge flapper 154 is raised (rotated counterclockwise as viewed in FIG. 2), so that the transfer sheet fed by the discharge rollers 142 is conveyed to the double-sided recording and multiple recording path (downward as viewed in FIG. 2) via the sheet discharge flapper 154.

Further, reference numeral 157 denotes a multiple flapper 157 that switches the transfer sheet conveying path to the double-sided recording path or the multi-recording path. If the multi-recording mode is set as the recording mode, the multiple flapper 157 is turned rightward (rotated clockwise as viewed in FIG. 2), so that the transfer sheet fed by the sheet discharge flapper 154 is conveyed once to an inversion path 155 via the multiple flapper 157 and then conveyed to a lower conveying path 158 via a pair of inverting rollers 163 and stored in a sheet refeed tray 156. On the other hand, if the double-sided recording mode is set, the multiple flapper 157 is turned leftward (counterclockwise as viewed in FIG. 2), so that the transfer sheet fed by the sheet discharge flapper 154 is directly conveyed to the lower conveying path 158 without going through the inversion path 155 and stored in the sheet refeed tray 156.

The transfer sheets thus stored in the sheet refeed tray 156 are picked up sheet by sheet by a sheet feed roller 159, and guided to the resist rollers 137 via a path 160.

It should be noted that, when a transfer sheet is inverted and then discharged from the apparatus main body 100 toward the discharging side, the sheet discharge flapper 154 is moved upward and the multiple flapper 157 is turned rightward to cause the transfer sheet with an image transferred thereon to be conveyed once toward the inversion path 155. Then, after the trailing end of the transfer sheet passes a first feed roller 162, the transfer sheet is conveyed to a second feed roller 162a by a pair of inverting rollers 163, and is discharged from the apparatus main body 100 by the discharge rollers 161.

Reference numeral 190 denotes a post-processing device that aligns and staples transfer sheets discharged from the apparatus main body 100. If no setting for carrying out post-processing on a bundle of discharged sheets such as sorting or stapling has been made through the operation of an operating section 172, hereinafter referred to, transfer sheets are discharged sheet by sheet onto a discharged sheet tray 191 via a conveying path 194. If settings for carrying out post-processing on a bundle of discharged sheets are made, transfer sheets are conveyed sheet by sheet onto a conveying path 195 and are aligned and stacked on a processing tray 193. When one set of transfer sheets has been completely discharged, the transfer sheets are stapled and discharged in the form of a bundle onto the discharged sheet tray 191 or the discharged sheet tray 192. It should be noted that control is provided such that if settings for performing post-processing on a bundle of discharged sheets have been made, in principle, transfer sheets are discharged in a bundle onto the discharged sheet tray 192, but in the case where the discharged sheet tray 192 is full, for example, the transfer sheets are discharged onto the discharged sheet tray 191. The discharged sheet trays 191 and 192 are moved up and down by a motor, not shown, and are controlled such that one of them onto which a bundle of transfer sheets is to be discharged is positioned in a predetermined position before the start of image formation.

Reference numeral 196 denotes a non-image formation sheet inserting device located on the post-processing device 190. In the case where image formation or the like has already been carried out and a coversheet mode in which a non-image formation sheet on which no image is to be formed is inserted into a bundle of transfer sheets has been set via the operating section 172, described later, a non-image formation sheet stored in advance in the non-image formation sheet inserting device 196 is conveyed via the conveying path 197 to the conveying path 194 or the conveying path 195 to join transfer sheets discharged from the apparatus main body 100.

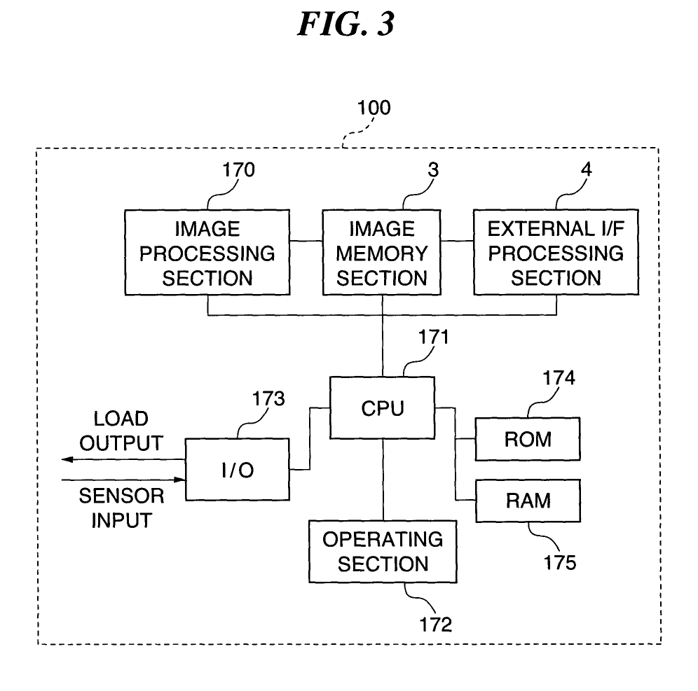

FIG. 3 is a block diagram showing the construction of a controller in the apparatus main body 100.

Reference numeral 171 denotes a CPU, which controls the overall operation of the apparatus main body 100, and to which are connected a ROM 174 which stores control programs, a work RAM 175 which provides a working area for the CPU 171, and input/output (I/O) ports 173 via an address bus and a data bus. A variety of output devices, not shown, such as a motor and a clutch controlled by the apparatus main body 100 and a variety of input devices, not shown, such as a sensor that detects the conveyance position of a transfer sheet being conveyed are connected to the input/output ports 173. The CPU 171 sequentially controls the input/output of data to and from the input and output devices via the input/output ports 173 according to the control programs stored in the ROM 174 to carry out image formation.

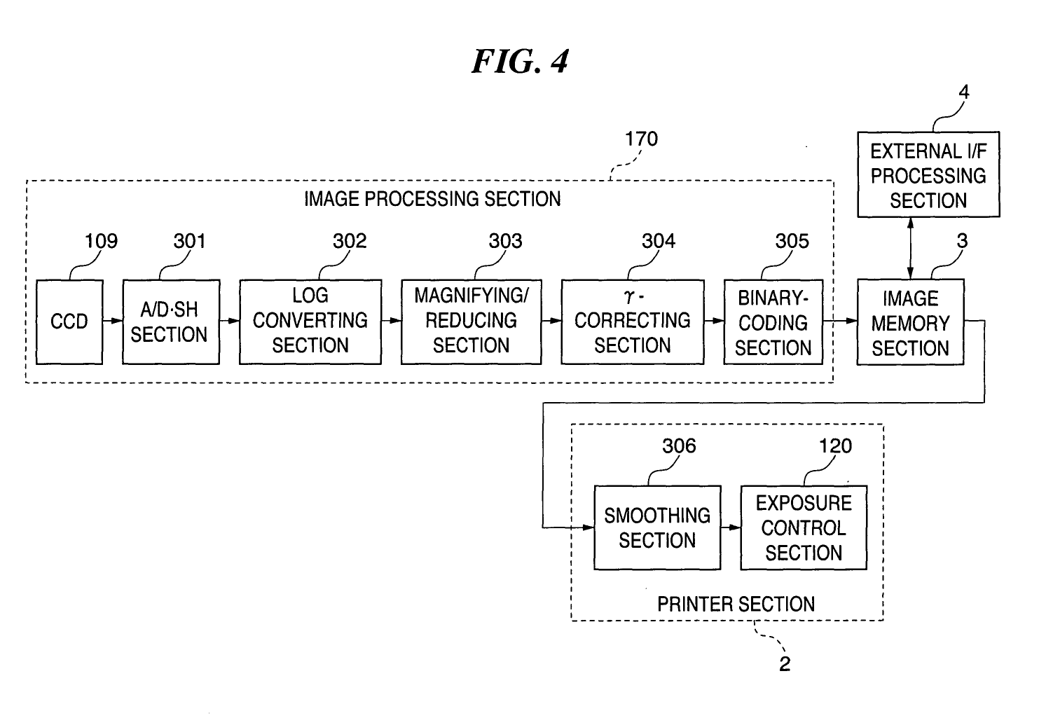

Further, the operating section 172 is connected to the CPU 171, which controls a display section and a key input section provided in the operating section 172. The user operates the key input section to instruct the CPU 171 to switch the image formation mode and the display, and the CPU 171 causes the display section to display the conditions of the apparatus main body 100 and the image formation mode set through the operation of the key input section. Connected to the CPU 171 are an image processing section 170 that performs processing on a signal converted into an electric signal by the image sensor section 109 and an image memory section 3 that stores the processed images. A detailed description will now be given of the image processing section 170 with reference to FIG. 4.

FIG. 4 is a block diagram showing the internal constructions of the image processing section 170 and a printer section 2. Note that the printer section 2 corresponds to the printer section (image forming section) appearing in FIG. 2.

An original image formed on the image sensor section 109 via the lens 108 is converted into an analog electric signal indicative of luminance data by the image sensor section 109. The resulting analog electric signal is inputted to an analog signal processing section, not shown, and is then subjected to sampling/holding, dark level correction, and so forth and then inputted to an A/D·SH section 301. The A/D SH section 301 carries out A/D conversion in which the inputted analog signal is converted into a digital signal, and performs shading correction on the digitalized signal (to correct for variations in characteristics between a plurality of photoelectric conversion elements constituting the image sensor section 109, and correct for variations in luminous intensity distribution characteristics of the original illumination lamp). The digitalized and shading-corrected signal is transmitted to a log conversion section 302. The log conversion section 302 includes a look-up table (LUT) for use in converting luminance data into density data, and outputs a table value (density data) corresponding to the inputted luminance data with reference to the look-up table so that the luminance data can be converted into density data corresponding to the table value. A magnifying/reducing section 303 then magnifies or reduces the image to a desired magnification, and inputs the same to a γ-correcting section 304. The γ-correcting section 304 includes a look-up table (LUT) for use in outputting density data with printer characteristics being taken into consideration, and outputs density data with reference to the look-up table and adjusts the density data according to a density value set through the operating section 172. A binary coding section 305 then converts multi-valued density data into binary data. For example, 8-bit image data whose density values can be represented by any of “0” to “255” is converted into 1-bit data whose density value is represented by “0” or “1”, and image data with its volume having been reduced is stored in the image memory 3.

It should be noted that the number of gradations of the image is decreased from 256 to 2 by binary-coding, and this generally leads to considerable deterioration of an image in the case of image data with many halftones such as a photographic image. To address this problem, image data needs to be artificially expressed by halftones using binary data by an error diffusion method. In this method, after image data is binary-coded based on the assumption that the density data is designated by “1” when the value of multi-valued density data of one pixel is greater than a predetermined threshold, and the density data is designated by “0” when the value of multi-valued density of one pixel is equal to or smaller than a predetermined threshold, and then the difference between the multi-valued density data and the binary-coded density data is distributed as an error signal to peripheral pixels. On this occasion, an error caused by binary-coding is multiplied by a weighting coefficient on a matrix prepared in advance, and the resulting value is added to the peripheral pixels. In this way, the density mean value of an image as a whole can be stored with halftones thereof being artificially expressed by binary data.

The image data binary-coded by the binary-coding section 305 is transmitted to and stored in the image memory section 3. An external I/F processing section 4 receives binary-coded image data from an external apparatus, and the image data is transmitted and stored in the image memory section 3.

The image memory section 3 is comprised of a high-speed input/output page memory, and a mass storage memory (hard disk) capable of storing image data on a plurality of pages. The image data on the plurality of pages stored in the hard disk is controlled in output according to an edition mode designated through the operating section 172 of the apparatus main body 100. For example, if a sorting editing mode in which originals consisting of a plurality of pages (original bundle) are copied to make a plurality of copies each consisting of image data arranged in the page order, the automatic document feeder (DF) 180 repeatedly outputs image data of the originals, which are handled as an original bundle, as a set of image data from the hard disk. Namely, by repeatedly reading out and printing out a set of image data stored temporarily in the hard disk, the same function can be achieved as a sorter provided with a plurality of bins.

The image data outputted from the image memory section 3 is transmitted to a smoothing section 306 of the printer section 2. The smoothing section 306 performs interpolation on the image data in such a way as to smooth the contours of an image, and outputs the image data to the exposure control section 120. The exposure control section 120 forms an image based on the image data on a transfer sheet by performing processing described hereinbefore with reference to FIG. 2.

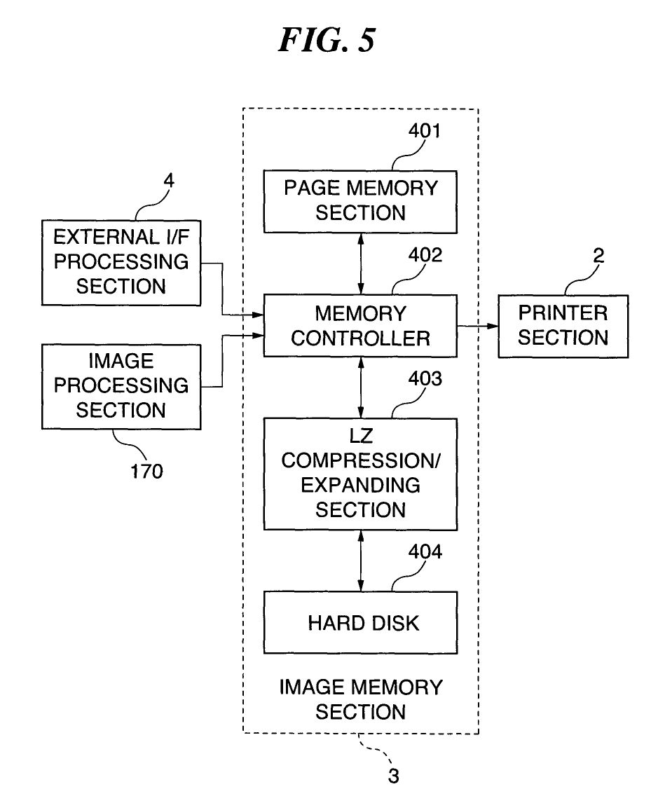

FIG. 5 is a block diagram showing the internal construction of the image memory section 3.

The image memory section 3 is comprised of a page memory section 401 implemented by a memory such as a DRAM, and a hard disk 404 as a mass storage device. A memory controller 402 provides control to write binary image data transmitted from the external processing section 4 and the image processing section 170 into the page memory section 401 and read out the same into the printer section 2. Further, the memory controller 402 accesses the hard disk 404 to control the input/output of image data. Further, the memory controller 402 transmits a DRAM refresh signal to the page memory 401, and controls access to the page memory 401 from the external I/F processing section 4, the image processing section 170, and the hard disk 404. Further, the memory controller 402 determines write address for writing to the page memory section 401, read address and direction for reading out from the page memory section 401 in accordance with instructions given from the CPU 171. By giving an instruction to the memory controller 402, the CPU 171 realizes a function of arranging a plurality of original images in a desired layout on the page memory section 401, a function of outputting images to the printer section 2, a function of outputting only a cut-out part of an image, and a function of rotating an image.

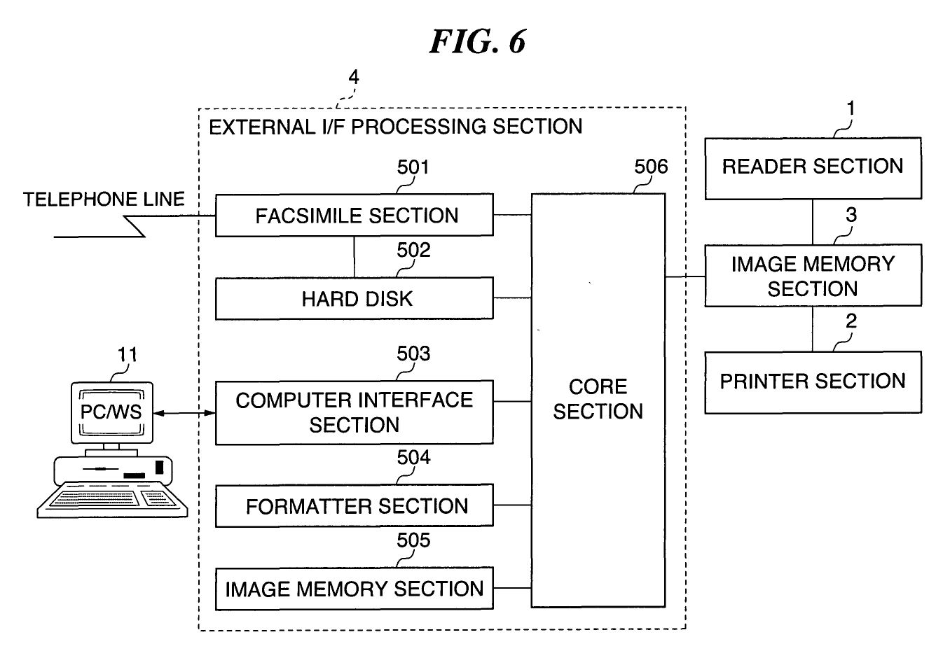

FIG. 6 is a block diagram showing the internal construction of the external I/F processing section 4.

The external I/F processing section 4 reads out binary image data written from a reader section 1 (corresponding to the above-mentioned scanner section) into the image memory section 3 and transmits the readout image data to an external apparatus, and stores binary image data transmitted from an external apparatus in the image memory section 3. The image data stored in the image memory section 3 is read out by the printer section 2 and printed out.

The external I/F processing section 4 is comprised of a core section 506, a facsimile section 501, a hard disk 502 that stores image data subjected to communication by the facsimile section 501, a computer interface section 503 which is connected to an external computer 11, a formatter section 504, and an image memory section 505. The facsimile section 501 is connected to a public telephone line via a modem, not shown, and receives and transmits facsimile communication data from and to the public telephone line. The facsimile section 501 uses images for facsimile transmission stored in the hard disk 502 to transmit image data at a designated time, or to transmit image data in response to a request made using a designated password at the destination, so that a facsimile function can be realized. In this way, once image data read out from the reader section 1 and stored in the image memory section 3 has been read out from the image memory section 3 and written into the hard disk 502 so as to be transmitted by facsimile, facsimile transmission can be carried out without using the reader section 1 and the image memory section 3 to perform the facsimile function.

The computer interface section 503 provides interface for data communication with the external computer 11, and functions as a LAN, a serial I/F, a SCSI I/F, a Centronics I/F, or the like. The computer interface section 503 provides interface to notify the external computer 11 of the statuses of the printer section 2 and the reader section 1, and to transfer image data read by the reader section 1 to the external computer 11 or another external apparatus in accordance with an instruction from the external computer 11 or the operation of the operating section 172 operated by the user (FIG. 3). Further, the computer interface section 503 also receives print image data transmitted from the external computer 11. The print image data transmitted from the external computer 11 is written in a printer code peculiar to the computer 11, and hence the formatter section 504 converts the print image data into raster image data suitable for image formation to be carried out by the printer section 2.

The formatter section 504 expands the print image data into the raster image data by means of the image memory section 505. The image memory section 505 is used as a work area for the formatter section 504 during expansion into raster image data, and is also used for realizing a function of transmitting image data from the reader section 1 to the external computer 11 or another external apparatus via the image memory section 3 and the computer interface section 503 (image scanner function). Specifically, the image memory section 505 is used for data format conversion as described above when image data read out from the image memory section 3 is converted into data with its data format suitable for the external computer 11 or another external apparatus and is transmitted from the computer interface section 503.

The core section 506 controls and manages the transfer of data between the facsimile section 501, the computer interface section 503, the formatter section 504, the image memory section 505, and the image memory section 3. Therefore, exclusive access control and priority control are provided under the control of the core section 506 to enable proper image output irrespective of whether a plurality of image output sections are provided in the external I/F processing section 4 and whether the number of image transfer paths extending to the image memory section 3 is 1.

Next, a description will now be given of how sheet margin data are collected and stored by each image forming apparatus used for distributed printing. Note that the sheet margin data is indicative of differences between the maximum size of an image which can be formed on a sheet (transfer sheet) by each image forming apparatus and the sheet size with respect to the leading end, trailing end, right end, and left end of the sheet in a conveying direction thereof.

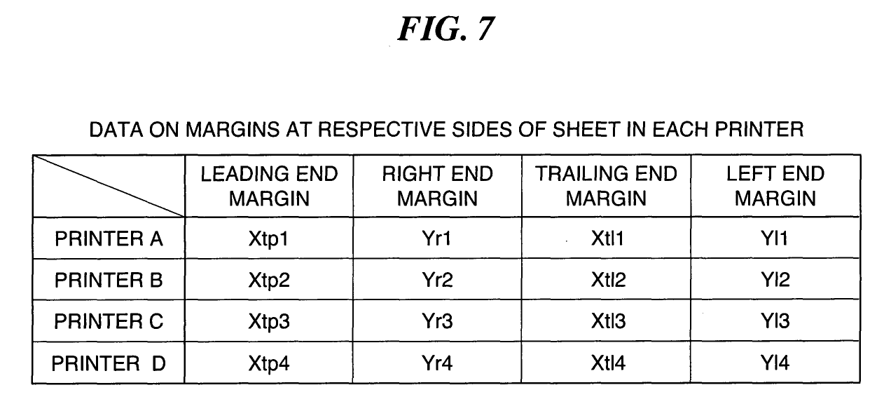

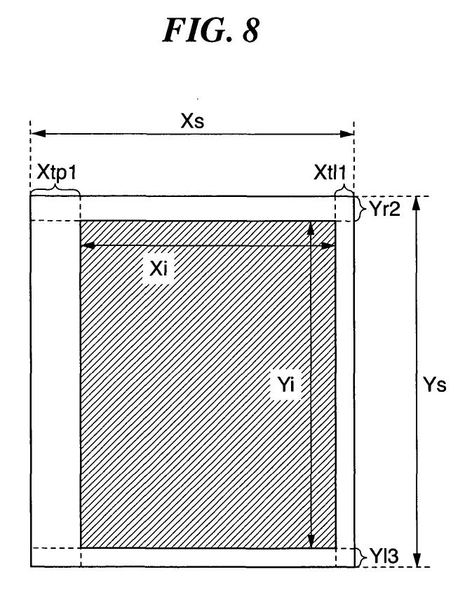

The image data server 003 appearing in FIG. 1 is usually implemented by a computer having a server function or an equivalent apparatus, and the user sets sheet margins for all of the image forming apparatuses 005a to 005c and 007, which are to be used for distributed printing, in advance in a storage medium of the computer or the equivalent apparatus. FIG. 7 is a diagram of a data table showing the relationship between sheet margins at the leading end, trailing end, right end, and left end and identifiers (A, B, C, and D) for identifying respective image forming apparatuses. This data table is stored in the storage medium.

As an alternative to the above described method in which the user sets sheet margins in advance, the image data server 003 may communicate with the image forming apparatuses 005a to 005c and 007 via the LAN 001 to collect sheet margin data thereof and create a data table as shown in FIG. 7.

It should be noted that the sheet margin data is collected when the image forming apparatuses 005a-005c and 007 or the image data server 300 is installed. Alternatively, the image data server 003 may collect sheet margin data by scheduled or periodic polling. Still alternatively, the image data server 003 may access the image forming apparatuses 005a to 005c and 007 when a distributed output print job request, which requests distributed printing, is given to the image data server 300.

Similarly, in the case where the printing system is constructed as shown in FIG. 1B using the master printer 004 in place of the image data server 003, a data table as shown in FIG. 7 is set in advance on a storage medium of the master printer 004. Alternatively, the master printer 004 may communicate with the image forming apparatuses 006a to 006c and 008 via the LAN 002 to collect sheet margin data and create the data table.

It should be noted that sheet margins may be fixed values which are peculiar to each image forming apparatus and are determined irrespective of the sheet size. Specifically, there may be the case where the sheet margins are represented irrespective of the sheet size by a difference between a predetermined reference size of each image forming apparatus and the maximum size of an image that can be formed by the image forming apparatus. The present invention is applied to such a case as well as the case where the sheet margins are set for each sheet size as a difference between the maximum size of an image that can be formed on a sheet (transfer sheet) by each image forming apparatus and the sheet size. The sheet margins described with reference to FIG. 7 and FIG. 8, referred to later, are set for each sheet size, and FIGS. 7 and 8 illustrate an example of the sheet margins for a certain sheet size.

A description will now be given of how the optimum margins common to all the image forming apparatuses are determined with reference to FIG. 8.

FIG. 8 is a view showing the optimum margins.

The image data server 003 or the master printer 004 selects respective maximum values of sheet margins, which are common to the image forming apparatuses, at the leading end, trailing end, right end, and left end for the same sheet size. For example, if the relationship between leading end margins is represented by Xtp1>Xtp2>Xtp3>Xtp4, Xtp1 is selected. Similarly, if the relationship between right end margins is represented by Yr2>Yr1>Yr3>Yr4, Yr2 is selected. If the relationship between trailing end margins is represented by Xtl1>Xtl2>Xtl3>Xtl4, Xtl1 is selected. If the relationship between left end margins is represented by Y13>Y12>Y11>Y14, Y13 is selected. The maximum values Xtp1, Yr2, Xtl1, and Y13 thus selected are shown in FIG. 8.

The maximum values selected in the above-mentioned manner are regarded as margins common to the image forming apparatuses in distributed printing. The size XixYi of an effective image area common to the image forming apparatuses is determined based on the selected maximum margins and the size XsxYs of a transfer sheet used for distributed printing. The size of an image on each page in a print job is compared with the determined effective image area to correct the image data, and the resulting image data is transmitted to the corresponding image forming apparatus so that distributed printing can be realized. As a result, even if the sizes of effective image areas peculiar to the respective image forming apparatuses are different from each other, printouts with effective image areas of the same size can be obtained by distributed printing.

In FIG. 8, Xtp1, Yr2, Xtl1, and Y13 are selected as the maximum values, i.e. the optimum margins at the leading end, right end, trailing end, and left end, respectively, of an image. These values are subtracted from the sheet width Ys and the sheet length Xs to find values Xi and Yi, and an area specified by the values Xi and Yi is regarded as an effective image area common to the image forming apparatuses in the current print job.

In the example shown in FIG. 8, it is assumed that margins are provided at four sides of a sheet. However, even in the case where a margin is provided only at one side of an image, for example, at the leading end of an image, or in the case where margins are provided only at two sides of an image, for example, at the leading end and trailing end of an image or at the right end and left end of an image, an effective image area may be determined by selecting the maximum value or values at an end or respective ends in the manner as described above.

A description will now be given of the procedure for carrying out a distributed printing process by the image data server 003 or the master printer 004.

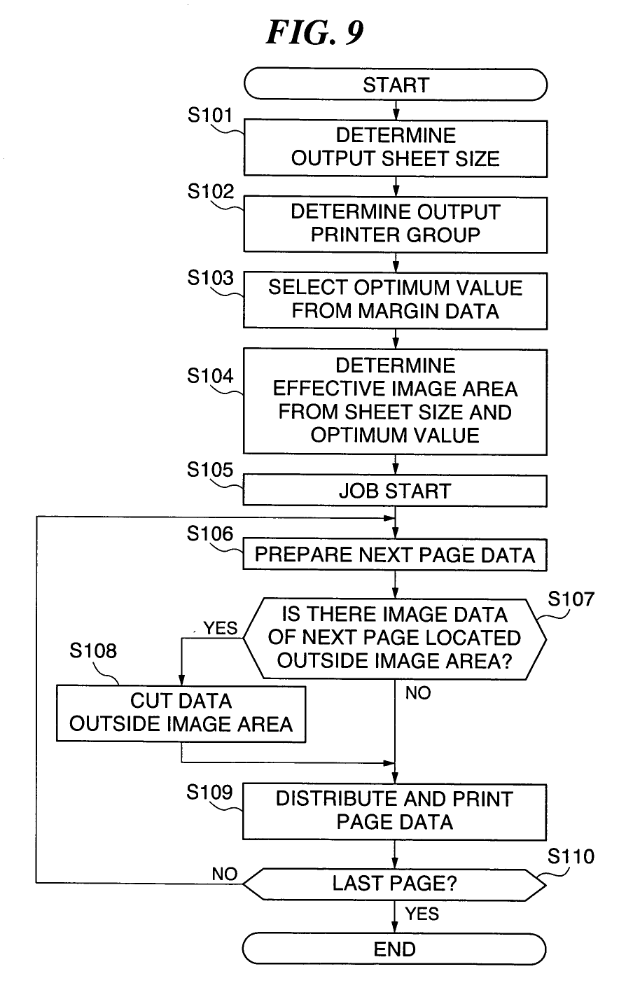

FIG. 9 is a flow chart showing the distributed printing process carried out by the image data server 003 or the master printer 004 according to the first embodiment.

The distributed printing process according to the present embodiment is started when the image data server 003 or the master printer 004 receives a print job request, which requests distributed printing, from the computer 009 or 010 or any of the multi-function machines 005a-005c or 006a-006c (hereinafter referred to as the “host apparatus”) including the scanners.

In a step S101, the image data server 003 or the master printer 004 determines the output sheet size according to properties of the requested job.

In a step S102, the image forming apparatuses which are to be used to output the distributed output print job are determined according to properties of the requested job, properties of the image forming apparatus group, or the like.

In a step S103, the maximum values, i.e. the maximum margins are selected according to the procedure described with reference to FIG. 8 by referring to the data table showing sheet margin data on the respective image forming apparatuses designated for distributed printing.

In a step S104, an effective image area for the current distributed output print job is determined according to the output sheet size determined in the step S101 and the optimum margins selected in the step S103.

In a step S105, the print job for each page is started based on the data obtained in the steps S101 through S104 as job properties.

In a step S106, data for the next page (next page data) in the print job is prepared.

In a step S107, it is determined whether or not the next page data includes data to be printed outside the effective image area determined in the step S104. If the determination result is positive, the process proceeds to a step S108, and if the determination result is negative, the process proceeds to a step S109.

In the step S108, processing is performed on image data for the next page such that part of an image outside the effective image area is cut, and only part of the image inside the effective image area is made effective.

In the step S109, the image data for the next page is distributed to the corresponding image forming apparatuses, which are caused to print the image data.

In a step S110, it is determined whether the next page is the last page of the print job or not. If it is determined that the next page is not the last page, the process returns to the step S106 to prepare next page data.

If it is determined in the step S110 that the next page is the last page, the distributed printing process is terminated.

In this way, according to the present embodiment, even if a plurality of image forming apparatuses are used to carry out distributed printing, the sizes of effective image areas on all pages are the same, and hence printouts with a uniform image quality as a whole can be obtained.

A description will now be given of a printing system according to a second embodiment of the present invention.

The second embodiment is basically identical in construction with the first embodiment, and hence duplicate description thereof is omitted.

A distributed printing process carried out by the image data server 003 or the master printer 004 according to the present embodiment is partially different from the one according to the first embodiment.

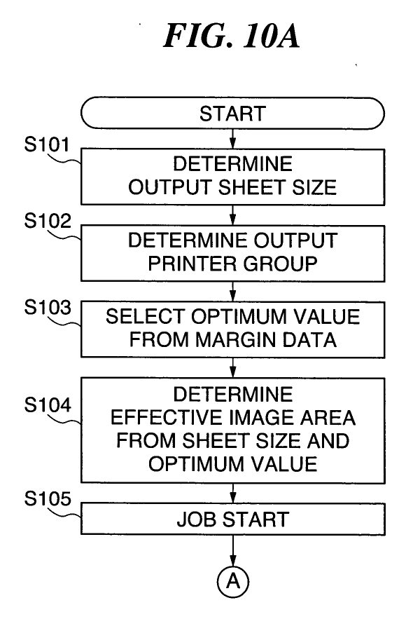

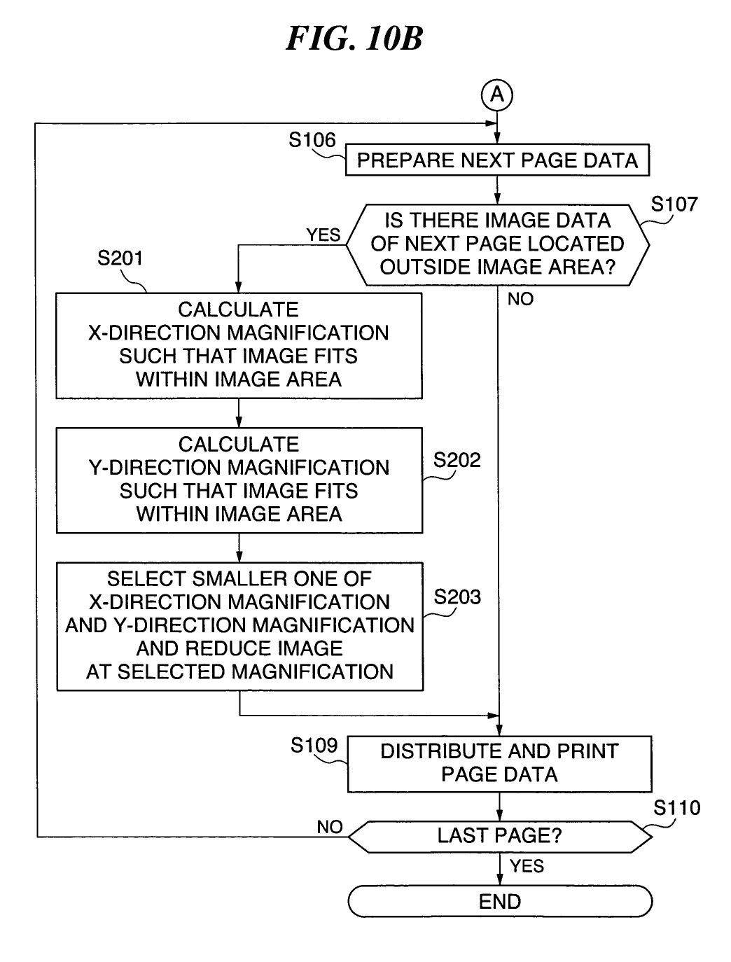

FIGS. 10A and 10B are flow chart showing the procedure of the distributed printing process carried out by the image data server 003 or the master printer 004 according to the present embodiment. In FIGS. 10A and 10B, steps which are identical with those of the first embodiment are designated by identical reference numerals, and duplicate description thereof is omitted.

In the present embodiment, steps S201 to S203 are provided in place of the step S108 of the first embodiment.

In the step S201, an X-direction magnification (smaller than 1), at which the size of the image to be created based on the next page data is changed, is determined according to the sub-scanning direction (X-direction) length Xi of the effective image area determined in the step S104 and the X-direction length of the image to be created based on the next page data so that the image can fit within the effective image area.

In the step S202, a Y-direction magnification (smaller than 1), at which the size of an image to be created based on the next page data is changed, is determined according to the main scanning direction (Y-direction) length of the effective image area determined in the step S104 and the Y-direction length of the image to be created based on the next page data so that the image can fit within the effective image area.

In the step S203, the smaller one (the greater reduction ratio) of the X-direction magnification and the Y-direction magnification calculated in the steps S201 and S202 is selected, and the image to be created based on the next page data is reduced at the selected magnification in both the X-direction and the Y-direction. The reduction of the image at the predetermined magnification is carried out using a known method.

Although in the present embodiment, whether next page data includes data to be printed outside the effective image area or not is determined on a page-by-page basis, and if the determination result is positive, i.e., if part of the image is located outside the effective image area, the reduction ratio is determined so that the entire image can fit within the effective image area, the present invention is not limited to this, but the same reduction ratio may be set for the X-direction and the Y-direction with respect to all pages of a print job.

In this way, according to the present embodiment, even if a plurality of image forming apparatuses are used to carry out distributed printing, the sizes of effective image areas on all pages are the same, and hence printouts with a uniform image quality as a whole can be obtained. Further, since the output image size is determined according to the effective image area by adjusting the magnification of an image, image chipping can be prevented.

A description will now be given of a third embodiment of the present invention.

The present embodiment is basically identical in construction with the second embodiment, and hence duplicate description thereof is omitted.

A distributed printing process carried out by the image data server 003 or the master printer 004 according to the present embodiment is partially different from the one according to the second embodiment.

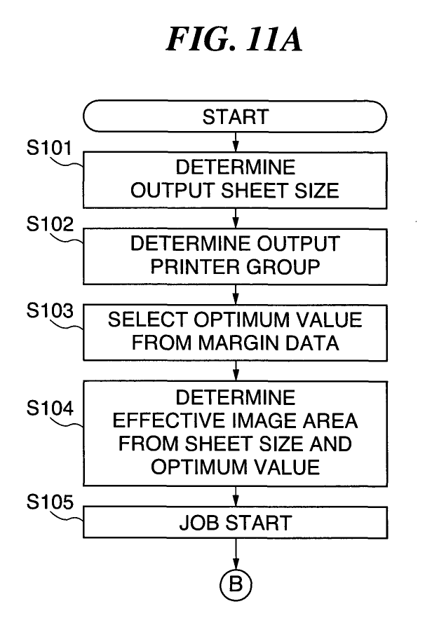

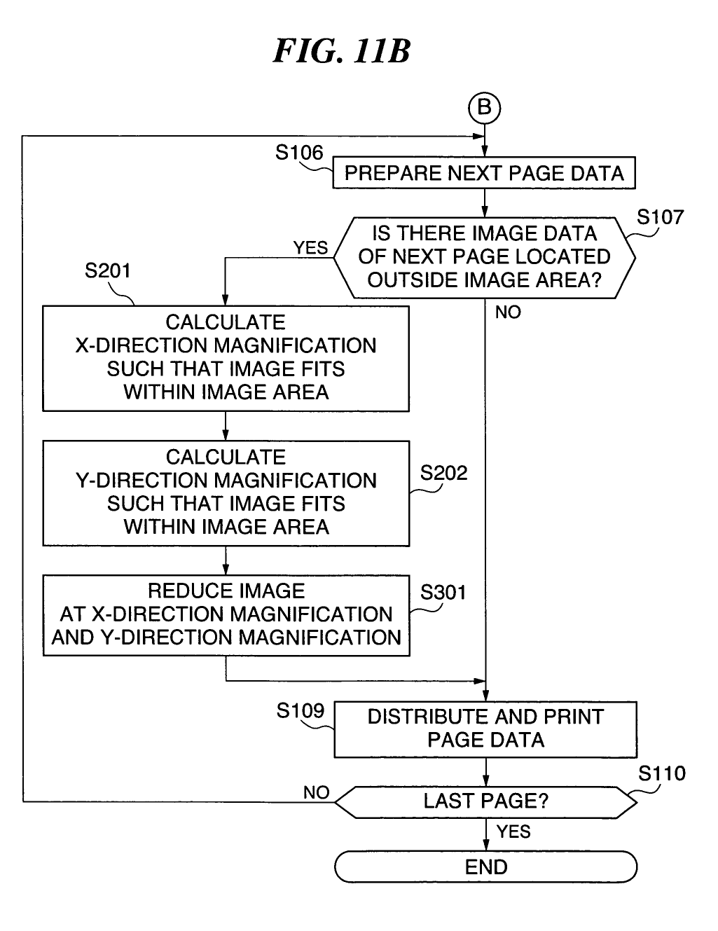

FIGS. 11A and 11B are flow chart showing the procedure of the distributed printing process carried out by the image data server 003 or the master printer 004 according to the present embodiment. In FIGS. 11A and 11B, steps which are identical with those of the second embodiment are designated by identical reference numerals, and duplicate description thereof is omitted.

In the present embodiment, a step S301 is provided in place of the step S203 of the second embodiment.

In the step S301, image data is obtained by reducing the mage to be created based on the next page data in the X-direction thereof at the X-direction magnification calculated in the step S201 and in the Y-direction thereof at the Y-direction magnification calculated in the step S202.

Although in the present embodiment as well, whether next page data includes data to be printed outside the effective image area or not is determined on a page-by-page basis, and if the determination result is positive, i.e., if part of the image is located outside the effective image area, the reduction ratio is determined so that the entire image can fit within the effective image area, the present invention is not limited to this, but the same reduction ratio may be set for the X-direction and the Y-direction with respect to all pages of a print job.

In this way, according to the present embodiment, as is the case with the second embodiment, even if a plurality of image forming apparatuses are used to carry out distributed printing, the sizes of effective image areas on all pages are the same, and hence printouts with a uniform image quality as a whole can be obtained. Further, since the output image size is determined according to the effective image area by adjusting the magnification of an image, image chipping can be prevented.

A description will now be given of a fourth embodiment of the present invention.

The present embodiment is basically identical in construction with the first embodiment, and hence duplicate description thereof is omitted.

A distributed printing process carried out by the image data server 003 or the master printer 004 according to the present embodiment is partially different from the one according to the first embodiment.

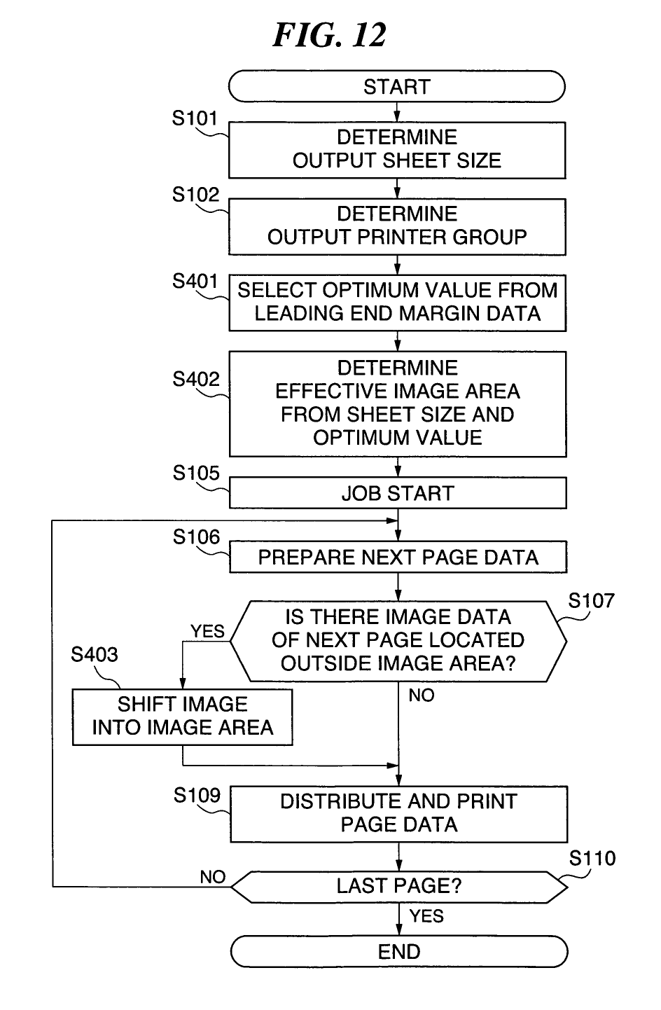

FIG. 12 is a flow chart showing the procedure of the distributed printing process carried out by the image data server 003 or the master printer 004 according to the present embodiment. In FIG. 12, steps which are identical with those of the first embodiment are designated by identical reference numerals, and duplicate description thereof is omitted.

In the present embodiment, steps S401 to S403 are provided in place of the step S103, S104, and S108 of the first embodiment.

In the step S401, the maximum value, i.e., the optimum margin at the leading end of a sheet is selected based on sheet leading end margin data on the respective image forming apparatuses, which are to be used for distributed printing, according to the procedure described before with reference to FIG. 8.

In the step S402, an effective image area in the requested print job subjected to distributed printing is determined according to the output sheet size determined in the step S101 and the optimum sheet leading end margin selected in the step S401.

If it is determined in the step S107 that part of an image at the leading end of a sheet is located outside the effective image area, the process proceeds to the step S403 wherein image data is created by shifting the part of the image located outside the effective image area into the effective image area.

Although in the present embodiment, an effective image area common to the image forming apparatuses is determined by focusing on the margin at the leading end of a sheet, and if page data includes data to be printed outside the effective image area at the leading end of the sheet such that the image does not fit within the effective image area, part of the image which is located outside the effective image area is shifted into the effective image area, the present invention is not limited to this, but such processing may be performed by focusing on the margin at any other part of a sheet.

Further, although in the present embodiment, whether next page data includes data to be printed outside the effective image area is determined on a page-by-page basis, and if the determination result is positive and the image does not fit within the effective image area, part of the image which is located outside the effective image area is shifted into the effective image area, the present invention is not limited to this, but images may be shifted by the same amount for all pages of a print job.

In this way, according to the present embodiment, even if a plurality of image forming apparatuses are used to carry out distributed printing, an image to be outputted is shifted so that it can fit within the effective image area, and hence image chipping can be prevented. In particular, by performing such simple processing as image shifting in the case where data of all pages are identical in size and different only in arrangement, it is possible to arrange images at the same position on all pages and to obtain printouts with a uniform image quality as a whole.

A description will now be given of a fifth embodiment of the present invention.

The present embodiment is basically identical in construction with the first embodiment, and hence duplicate description thereof is omitted.

A distributed printing process carried out by the image data server 003 or the master printer 004 according to the present embodiment is partially different from the one according to the first embodiment.

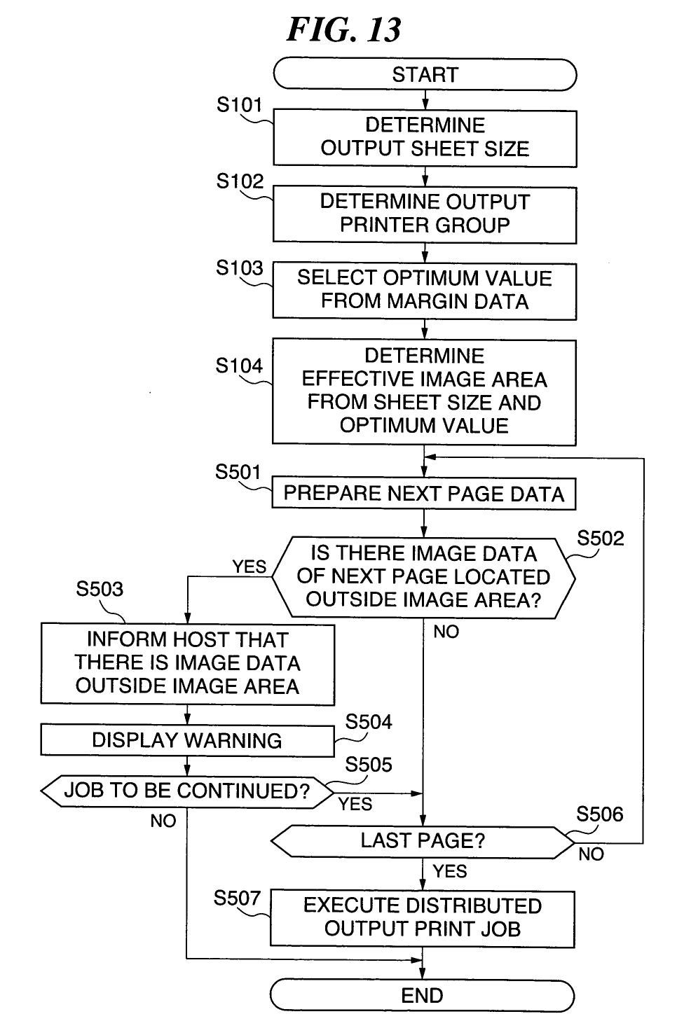

FIG. 13 is a flow chart showing the procedure of the distributed printing process carried out by the image data server 003 or the master printer 004 according to the present embodiment. In FIG. 13, steps which are identical with those of the first embodiment are designated by identical reference numerals, and duplicate description thereof is omitted.

In the present embodiment, steps S501 to S507 are provided in place of the step S105 to S110 of the first embodiment.

In the step S501, next page data in a print job, which is to be distributed as data to the image forming apparatuses, is prepared.

In the step S502, it is determined whether or not the next page data includes data to be printed outside the effective image area determined in the step S104. If the determination result is positive, the process proceeds to the step S503, and if the determination result is negative, the process proceeds to the step S506.

In the step S503, the host apparatus (the computer 009 or 010 or the multi-function machine 005a-005c or 006a-006c) is notified that the next page data includes data to be printed outside the effective image area, i.e., an output image is to be chipped.

In the step S504, a warning is displayed on a display section of the host apparatus according to the notification, so that the user can be informed that the image to be outputted will be chipped. The user then determines whether the print job is to be continued or not.

In the step S505, if the user decides to continue the print job with reference to as a result of the warning being displayed on the display section of the host apparatus, the process proceeds to the step S506, and if the user decides to discontinue the print job, the present process is terminated.

In the step S506, it is determined whether the next page is the last page of the print job or not. If the next page is not the last page, the process returns to the step S501, and if the next page is the last page, the process proceeds to the step S507.

In the step S507, processing corresponding to the steps S106 to S110 of the first embodiment shown in FIG. 9 is performed.

In this way, according to the present embodiment, even if a plurality of image forming apparatuses are used to carry out distributed printing, the sizes of effective image areas on all pages are the same, and hence printouts with a uniform image quality as a whole can be obtained. Further, when part of an image to be outputted is located outside the effective image area, a warning is displayed to inform the user that the output image is to be chipped, thus preventing the appearances of printed images on respective pages from differing.

A description will now be given of a sixth embodiment of the present invention.

The present embodiment is basically identical in construction with the first embodiment, and hence duplicate description thereof is omitted.

A distributed printing process carried out by the host apparatus (the computer 090 or 010 or the multi-function machine 005a-005c or 006a-006c), the image data server 003, or the master printer 004 according to the present embodiment is partially different from the one according to the first embodiment.

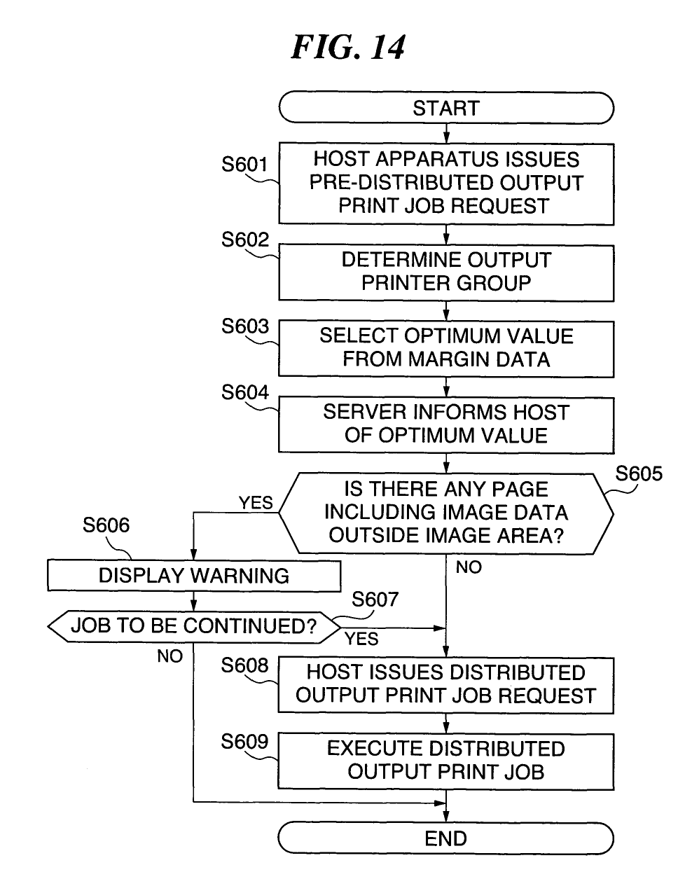

FIG. 14 is a flow chart showing the procedure of the distributed printing process carried out by the host apparatus, the image data server 003, or the master printer 004 according to the present embodiment. In the present embodiment, the host apparatus determines whether or not each page data in a distributed output print job is image data capable of being outputted without chipping.

In a step S601, the host apparatus issues a pre-distributed output print job execution request before issuing a print job which is required to be outputted by distributed printing to the image data server 003 or the master printer 400. The pre-distributed output print job execution request is intended for the host apparatus to request the image data server 003 or the master printer 004 to transmit information for use in determining whether each page data is image data capable of being outputted without chipping, i.e. information indicative of the maximum values of sheet margins, i.e. the optimum margins.

In the step S602, the image data server 003 or the master printer 004 having received the pre-distributed output print job execution request determines the image forming apparatuses, which are to be used to output the distributed output print job, according to properties of the pre-distributed output print job execution request or properties of the image forming apparatus group.

In the step S603, the image data server 003 or the master printer 004 selects the maximum values, i.e., the optimum margins by referring to a data table showing sheet margin data relating to the respective image forming apparatuses, which are to be used to output the distributed output print job, according to the procedure described before with reference to FIG. 8.

In the step S604, the image data server 003 or the master printer 004 transmits data on the selected optimum margins to the host apparatus.

In the step S605, the host apparatus having received the data on the optimum margins determines an effective image area in the distributed output print job according to the size of a sheet to be outputted and the optimum margins. The host apparatus then determines whether or not there is any page including an image to be printed outside the effective image area among image data of respective pages in the distributed output print job. If the determination result is positive, the process proceeds to the step S606, and if the determination result is negative, the process proceeds to the step S608.

In the step S606, the host apparatus displays a warning on the display section thereof to notify the user that a page or pages on which an image or images is/are chipped is to be outputted.

In the step S607, if the user decides to continue the print job as a result of the notification, the process proceeds to the step S608, and if the user decides to discontinue the print job, the present process is terminated.

In the step S608, the host apparatus issues a distributed output print job request that requests execution of distributed printing to the image data server 003 or the master printer 004.

In the step S609, the image data server 003 or the master printer 004 having received the distributed output print job request perform processing corresponding to the steps S107 to S110 of the first embodiment shown in FIG. 9.

In this way, according to the present embodiment, even if a plurality of image forming apparatuses are used to carry out distributed printing, the sizes of effective image areas on all pages are the same, and hence printouts with a uniform image quality as a whole can be obtained. Further, when part of an image to be outputted is located outside an effective image area, a warning is displayed to inform the user that the output image is to be chipped, thus preventing a difference in appearance of printed images between pages.

Although in the above described embodiments, each image forming apparatus performs black-and-white printing as described before with reference to FIG. 2, but the image forming apparatuses applied to the printing system according to the present invention are implemented by one or more image forming apparatuses which perform black-and-white printing, one or more image forming apparatuses which perform color printing, or a combination of one or more image forming apparatuses which perform black-and-white printing and one or more image forming apparatuses which perform color printing.

Further, although in the above described first to fourth embodiments, page data including an image to be printed outside the effective image area is subjected to processing such as image cutting, reducing, or shifting, the present invention is not limited to this, but it may be configured such that the user selects any one of the above processing in advance or when carrying out distributed printing.

It is to be understood that the object of the present invention may also be accomplished by supplying a system or an apparatus with a storage medium in which a program code of software which realizes the functions of any of the above described embodiments is stored, and causing a computer (or CPU or MPU) of the system or apparatus to read out and execute the program code stored in the storage medium.

In this case, the program code itself read from the storage medium realizes the functions of any of the above described embodiments described above, and hence the storage medium on which the program code is stored constitutes the present invention.

Examples of the storage medium for supplying the program code include a floppy (registered trademark) disk, a hard disk, an optical disk, a magnetic-optical disk, a CD-ROM, a CD-R, a CD-RW, DVD-ROM, a DVD-RAM, a DVD-RW, a DVD+RW, a magnetic tape, a nonvolatile memory card, and a ROM.

Further, it is to be understood that the functions of any of the above described embodiments may be accomplished not only by executing a program code read out by a computer, but also by causing an OS (Operating System) or the like which operates on the computer to perform a part or all of the actual operations based on instructions of the program code.

Further, it is to be understood that the functions of any of the above described embodiment thereof may be accomplished by writing the program code read out from the storage medium into a memory provided in an expansion board inserted into a computer or a memory provided in an expansion unit connected to the computer and then causing a CPU or the like provided in the expansion board or the expansion unit to perform a part or all of the actual operations based on instructions of the program code.

What is claimed is:

1. A printing system comprising:
a plurality of image forming apparatuses that carry out image formation on a sheet;
a margin storage device that stores margins in which no image is formed in the image formation carried out by each of said plurality of image forming apparatuses;
an optimum margin selecting device that selects an optimum margin having a maximum value from among the margins for each of said plurality of image forming apparatuses, stored by said margin storage device;
an image area calculating device that calculates an effective image area found from the optimum margin selected by said optimum margin selecting device and a size of the sheet on which the image formation is to be carried out; and
an image data adjusting device that adjusts image data for each of said plurality of image forming apparatuses such that an image to be formed based on the image data fits within the effective image area calculated by said image area calculating device.

2. A printing system according to claim 1, wherein said margin storage device stores respective margins at four ends of the sheet, and said optimum margin selecting device selects the optimum margin having the maximum value for each of the four ends.

3. A printing system according to claim 1, wherein said margin storage device, said optimum margin selecting device, said image area calculating device, and said image data adjusting device are provided in one of said plurality of image forming apparatuses.

4. A printing system according to claim 1, further comprising an image data server that distributes image data to said plurality of image forming apparatuses, and wherein said margin storage device, said optimum margin selecting device, said image area calculating device, and said image data adjusting device are provided in said image data server.

5. A printing system according to claim 1, comprising an input device that inputs the margins to be stored by said margin storage device through setting operations by a user.

6. A printing system according to claim 1, further comprising a collecting device that collects margins from said plurality of image forming apparatuses, transmits the margins to said margin storage device to cause said margin storage device to store the margins.

7. A printing system according to claim 1, wherein said image data adjusting device reduces the size of the image such that the image to be formed based on the image data fits within the effective image area.

8. A printing system according to claim 1, wherein said image data adjusting device erases part of the image which is located outside the effective image area.

9. A printing system according to claim 1, wherein said image data adjusting device shifts part of the image which is located outside the effective image area into the effective image area.

10. A printing system according to claim 1, wherein said image data adjusting device adjusts the image data for each of said plurality of image forming apparatuses using one method selected by a user from among a plurality of image data adjusting methods for fitting the image within the effective image area calculated by said image area calculating device.

11. A printing system comprising:
a plurality of image forming apparatuses that carry out image formation on a sheet;
a margin storage device that stores margins in which no image is to be formed in the image formation carried out by each of said plurality of image forming apparatuses;
an optimum margin selecting device that selects an optimum margin having a maximum value from among the margins for each of said plurality of image forming apparatuses, stored by said margin storage device;
an image area calculating device that calculates an effective image area found from the optimum margin selected by the optimum margin selecting device and a size of the sheet on which the image formation is to be carried out;
an out-of-area image determining device that compares the effective image area calculated by said image area calculating device with an image to be subjected to the image formation carried out by each of said plurality of image forming apparatuses, and determines whether part of the image is located outside the effective image area; and
a display device that displays a warning when said out-of-area image determining device determines that part of the image is located outside the effective image area.

12. A printing system according to claim 11, wherein said out-of-area image determining device is provided in one of said plurality of image forming apparatuses.

13. A printing system according to claim 11, further comprising an image data server that distributes image data to said plurality of image forming apparatuses, and wherein said out-of-area image determining device is provided in said image data server.

14. A printing system according to claim 11, further comprising a processing control device operable when said out-of-area image determining device determines that part of the image is located outside of the effective image area, for providing control to continue or discontinue the image formation in accordance with an instruction from a user.

15. A printing system according to claim 11, further comprising a host apparatus that instructs each of said plurality of image forming apparatuses to carry out distributed image formation, and wherein said out-of area image determining device and said display device are provided in said host apparatus, said host apparatus operating said out-of-area image determining device and said display device before instructing each of said plurality of image forming apparatuses to carry out the distributed image formation.

16. A printing system comprising:
a plurality of image forming apparatuses that are capable of carrying out distributed image formation according to an image forming job distributed to the plurality of image forming apparatuses;
an image area detecting device that detects a minimum size among maximum sizes in which image formation can be carried out by respective ones of said plurality of image forming apparatuses, and regards an area of the detected minimum size as a common effective image area; and
an image data adjusting device that adjusts image data to be subjected to the distributed image formation carried out by each of said plurality of image forming apparatuses such that an image to be formed based on the image data fits within the common effective image area detected by said image area detecting device.

17. A printing system according to claim 16, wherein said image data adjusting device reduces a size of the image such that the image to be formed based on the image data fits within the common effective image area.

18. A distributed image forming method applied to a printing system that includes a plurality of image forming apparatuses, and distributes an image forming job to the plurality of image forming apparatuses to cause the plurality of image forming apparatuses to carry out distributed image formation, comprising:
a storing step of storing margins in which no image is to be formed in the image formation carried out by each of the plurality of image forming apparatuses;
a selecting step of selecting an optimum margin having a maximum value from among the margins for each of the plurality of image forming apparatuses, stored in said storing step;
a calculating step of calculating an effective image area found from the optimum margin selected in said selecting step and a size of the sheet on which the image formation is to be carried out; and
an adjusting step of adjusting image data for each of said plurality of image forming apparatuses such that an image to be formed based on the image data fits within the effective image area calculated in said calculating step.

19. A distributed image forming method applied to a printing system that includes a plurality of image forming apparatuses, and distributes an image forming job to the plurality of image forming apparatuses to cause the plurality of image forming apparatuses to carry out distributed image formation, comprising:
a storing step of storing margins in which no image is to be formed in the image formation carried out by each of the plurality of image forming apparatuses;
a selecting step of selecting an optimum margin having a maximum value from among the margins for each of the plurality of image forming apparatuses, stored in said storing step;
a calculating step of calculating an effective image area found from the optimum margin selected in said selecting step and a size of the sheet on which the image formation is to be carried out;
a determining step of comparing the effective image area calculated in said calculating step with an image to be subjected to the image formation by each of the plurality of image forming apparatuses, and determining whether part of the image is located outside the effective image area; and
a displaying step of displaying a warning when it is determined in said determining step that part of the image is located outside the effective image area.

20. A distributed image forming method applied to a printing system that includes a plurality of image forming apparatuses, and distributes an image forming job to the image forming apparatuses to cause the plurality of image forming apparatuses to carry out distributed image formation, comprising:
an image area detecting step of detecting a minimum size among maximum sizes in which the image formation is can be carried out by respective ones of the plurality of image forming apparatuses, and regarding an area of the detected minimum size as a common effective image area; and
an image data adjusting step of adjusting image data to be subjected to the distributed image formation carried out by each of the plurality of image forming apparatuses such that an image to be formed based on the image data fits within the common effective image area detected in said image area detecting step.
